(19) United States
(12) Patent Application Publication
(10) Pub. No.: US 2003/0166427 A1
(43) Pub. Date: Sep. 4, 2003

(54) Indexed cycle derailleur

(76) Inventors: Tom W. Dillon, Lakewood, CO (US); Ruth M. Dillon, Lakewood, CO (US)

Correspondence Address: LEE G. MEYER, ESQ., MEYER & ASSOCIATES, LLC, 17462 E. POWERS DRIVE, CENTENNIAL, CO, 80015-3046, US

(21) Appl. No.: 10/091,095

(22) Filed: Mar. 1, 2002

(51) Int. Cl. F16H 9/00; F16H 61/00

(52) U.S. Cl. 474/80; 474/82

(57) ABSTRACT

A cycle derailleur incorporates an indexing mechanism (indexer) as an integral part of the derailleur. More specifically, the indexer is a physical part of the derailleur structure, and is activated by the pull or release of a cable (e.g., operated via gearshift control on a cycle handlebar). Actuation of the indexer requires exertion of a threshold force sufficient to overcome built-in resistance of a detent-style, spring-loaded mechanism. As shifts are made from one gear to another, the indexer is adapted to urge the derailleur into precision alignment with each selected gear. In each of the described embodiments, the indexed derailleur and a method for indexing (digitizing) gear changes by means of, for example, a movable bearing/detent mechanism, are characterized by a deformable parallelogram linkage actuated via the cable through a gearshift control. The result is an improved cycle shifter system that fosters accuracy and avoids derailleur mislocation between shifts.

### BACKGROUND OF THE INVENTION

1. Field of the Invention

This invention relates to cycle derailleurs, and specifically to mechanically actuated derailleurs that are indexed to positively effect gear change accuracy. More particularly, the invention is directed to improvements in the indexing functions of cycle (e.g., bicycle) derailleurs for enhancing such accuracy.

2. Discussion of the Related Art

“Multi-speed” cycles are generally well known in the art, with the most familiar being a bicycle. Such cycles are usually designed to provide three, five, ten, or more distinct speeds. There are numerous ways of providing the distinct ratios, which provide the multi-speed capability. In the case of a ten-speed cycle, for example, there are two distinct “gear clusters” or sprocket wheels. (The terms “gear” and “sprocket” or “sprocket wheel” are used interchangeably, herein, as well as the terms “cluster” and “cassette”.) In a typical rear cassette of a ten-speed cycle, the number of gear selectable sprocket wheel positions is five. Thus, the rear gear cluster comprises five gears having different numbers of teeth, the gears situated fixedly about a wheel hub in a coaxial side-by-side relationship. As those skilled in the art will appreciate, selection of any one of the five sprocket gear positions of the cassette is achieved via a rear derailleur device, which effects the shifting of the cycle chain position axially (i.e., laterally) or from sprocket-to-sprocket, in a manner such that the cycle chain is disengaged from a first sprocket, and is caused to move laterally to a selected second coaxial sprocket.

In the case of the ten-speed cycle, there is also typically provided a second front gear cluster comprised of two or more sprockets having different numbers of teeth, and wherein front gear sprockets are also situated in a coaxial side-by-side relationship. The front gear cluster is, as is the rear cluster, also provided with a derailleur device for shifting the cycle chain position laterally, or in a manner such that the chain disengages a first sprocket and is then caused to move to a selected second coaxial sprocket. In the case of the described ten-speed cycle, the front gear cassette comprises only two sprocket gears. With respect to both front and rear gear clusters, the chain is adapted to re-engage any desired gear in either cluster as a function of any particular selected gear ratio. Thus, in the described ten-speed cycle, the front derailleur effects shifting of the cycle chain between the two gears of the front gear cluster, while the rear derailleur effects shifting of the cycle chain between the five gears of the rear gear cluster.

In most prior art multi-speed cycles, two levers provided on the frame are connected to cables passing respectively to the front and rear derailleurs for effecting gearshifts. Each of the cables is normally maintained in tension by a spring mechanism built into the respective derailleur, and shifting of gears is accomplished by moving one or both of the derailleurs via the cables. This is accomplished by manually pulling or pushing respective cable wires via the levers against the spring bias. A friction device normally retains each lever in its moved position, so that the cycle chain can be properly positioned on the selected front and rear gears. Movements of either or both levers between their extreme positions will operate the respective derailleurs to cause shifting between gear ratios as desired by an operator of the cycle.

In the ten-speed configuration described, and as is typical in most multi-speed cycles, the levers are typically operated independently of one another. Since the levers are normally mounted on a so-called front down tube, head tube, or the handlebars of the bicycle, a bicycle operator is required to steer the bicycle with one hand on the handlebars, and to use the other hand to successively operate one or both of the levers. As a general rule, the smoothness in gear speed changing is a function of the rider's deftness or skill with respect to shifting to a desired sprocket. In most cases, to shift gears on conventional prior art cycles in proper sequence requires a mental analysis on the part of the bicycle rider, or a memorization of proper operating sequences of the two levers. In this respect, there is no simple means for a bicycle rider to determine a particular gear position with absolute accuracy. Indeed, efforts to effect a shift via the rear derailleur from one gear to another of a rear cassette, particularly where an intended skip of at least one intermediate gear of the cassette is involved, often results in shifting to an undesired intermediate gear setting.

There are additional problems associated with prior art arrangements. In many cases, the shift lever stroking or positioning is often determined strictly by “feel” or guesswork. In such cases, there is no positive positioning of the derailleur with respect to any given selected gear because the lever stroke is subject to non-discrete motions throughout all intermediate positions.

In other cases, discrete motions are designed into the lever stroke, such as when detent mechanisms are employed. However, such detent mechanisms are heretofore located near or within the lever mechanism, i.e. on the front down tube, head tube, or handlebars of the bicycle frame. Generally, even after periods of relatively short usage, the cables stretch, resulting in inconvenient and occasionally even dangerous (e.g., if in midst of road traffic) mislocation of derailleur position relative to desired gear selection. Normally, the shifting is completed when the associated bicycle chain engages a selected gear. However, the shifting becomes incomplete when the derailleur is mis-positioned, or is otherwise not in a consistent position for selection of desired gear.

The effect of a stretched cable may therefore cause a derailleur to be positioned between gear positions, because as the cable stretches, misalignment of the derailleur position and the remotely positioned indexed lever is created. When such a detent mechanism is used after shift cables have become stretched, a rider will tend to continually visually examine the particular gears in the cluster over which the bicycle chain is passing to confirm proper gear engagement. This can be annoying, and even dangerous in some situations, particularly when the driver is in substantial traffic. Many attempts have been made to reduce the randomness of shifting the derailleur. One effort to reduce such randomness has involved the provision of a single cable that operates both the front and rear derailleurs.

### SUMMARY OF THE INVENTION

A cycle derailleur incorporates an indexing mechanism as an integral part of the derailleur structure. Upon activation by the pull or release of a cable (e.g., via gearshift control on the cycle handlebar), the derailleur is forced by an integral indexing mechanism to move into a selectable index position. This causes a derailleur pulley gear to be precisely aligned with a selected sprocket gear. The invention incorporates both an indexed derailleur device and a method for indexing (digitizing) gear changes of a cycle by means of, in one embodiment, a movable ball bearing detent mechanism.

In the one described embodiment, a bicycle derailleur incorporates an indexing mechanism (indexer) as an integral part of the derailleur. As a physical part of the derailleur structure the indexer is activated by the pull or release of a cable operated by a gearshift control on the handlebar of the bicycle. Actuation of the indexer requires exertion of a threshold force adequately sufficient to overcome a built-in resistance of a detent-received, spring-loaded ball bearing. As shifts are made from one gear to another, the indexer urges the derailleur into precision alignment with each selected gear. In each of the described embodiments, the indexed derailleur and method for indexing (digitizing) gear changes by means of the movable ball bearing detent mechanism are characterized by a deformable parallelogram linkage actuated by means of the cable through a gearshift control. The result is an improved cycle shifter system that encourages safety, as well as improved performance, through avoidance of derailleur-induced mislocations of the gear chain during shifts.

### BRIEF DESCRIPTION OF THE DRAWINGS

FIG. 1 is a perspective view of a bicycle that includes one described embodiment of the improved rear derailleur mechanism of the present invention.

FIG. 2 is an enlarged side view of a rear wheel of the bicycle of FIG. 1, providing an enlarged view of the improved rear derailleur mechanism.

FIG. 3 is a further enlarged side view of the subject improved rear derailleur mechanism.

FIG. 4A is a view along lines 4A-4A of FIG. 3 of one described embodiment of the improved rear derailleur mechanism.

FIG. 4B is a view along lines 4B-4B of FIG. 3 of a second described embodiment of the improved rear derailleur mechanism.

FIG. 5 is a side view similar to that of FIG. 3, but depicting an additional embodiment of the improved rear derailleur mechanism.

FIG. 6 is a perspective view of a portion of the improved derailleur mechanism of FIG. 5.

### DETAILED DESCRIPTION OF EMBODIMENTS

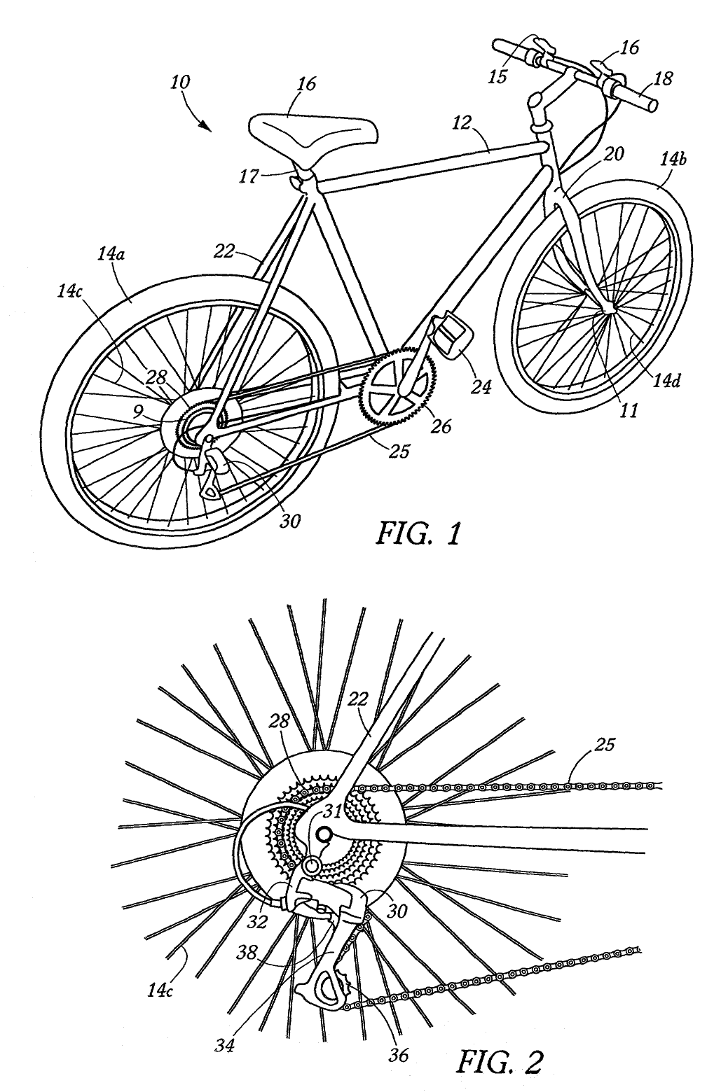

Referring initially to FIG. 1, a bicycle 10 is defined by a frame 12 to which are individually secured rear and front spoked wheels 14a and 14b. The rear wheel 14a contains spokes 14c attached to wheel hub 9, while the front wheel 14b contains spokes 14d, attached to wheel hub 11, as shown. The bicycle 10 further contains a seat 16 situated on a seat post 17 that projects upwardly from a portion of the bicycle frame 12.

Gearshift levers 15 and 16 situated on a handlebar 18 are adapted to swivel relative to the frame 12. The levers 15 and 16 are relatively movable on the handlebar 18 to effect shifting of gears as will be described herein below. The handlebar 18 is rigidly attached to a steering fork 20 that is also attached to, but movable with respect to, the frame 12 so as to swivel and to thus facilitate steering of the front wheel 14b, as will be appreciated by those skilled in the art.

A rear portion 22 of the frame 12 defines a portion of the frame to which the rear wheel 14a is attached. A pair of pedals 24 is adapted to operate a continuous chain 25 that extends between front and rear sprocket cassettes 26 and 28, respectively. In the described embodiment, the front sprocket cassette 26 comprises two axially aligned sprocket gears, and is situated in a lower mid-portion of the frame 12, as shown. The rear sprocket cassette 28 comprises five individual sprocket gears. As will be appreciated by those skilled in the art, the particular combination of gears between the front and rear cassettes defines a 10-speed bicycle.

Referring now also to FIG. 2, a rear derailleur 30 is attached to the rear portion 22 of the frame 12 via a connection bolt 31. The derailleur 30 is adapted to shift the chain 25 from one sprocket gear to another on the rear sprocket cassette 28. The movement of the derailleur 30 to effectuate such gear changes is achieved via movements of the gearshift lever 16 on the handlebar 18; the latter controls only the shifting of the rear derailleur. Conversely, a front derailleur (not shown) is normally situated adjacent the front sprocket cassette 26, and controlled by the gearshift lever 15. As the front derailleur is not a part of the present invention, its structure and operation are not particularly described herein.

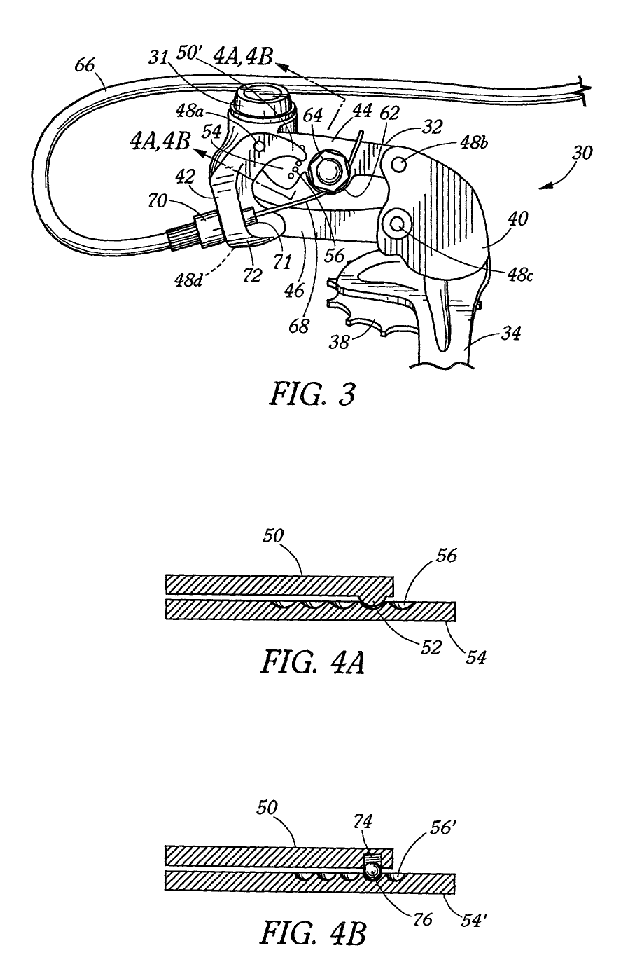

Referring to FIG. 2, the rear derailleur 30 is formed of an upper deformable parallelogram structure 32, and a lower pulley cage portion 34 secured to and supported by one deformable leg of the parallelogram structure 32, as will be described in reference to FIG. 3. The pulley cage 34 supports an idler pulley gear 36 as well as a chain guide pulley gear 38, as shown. Those skilled in the art will appreciate that the guide pulley gear 38 is adapted to precisely align the chain 25 with a sprocket gear of the rear sprocket cluster 28 in accordance with a desired gearshift selection performed by a cycle rider. Those skilled in the art will appreciate that the guide pulley gear 38 is cammed, so as to move laterally between limits of movement corresponding to the distance between first and fifth sprocket gear positions of the rear sprocket cassette 28. Such movement is in response to deformation of the parallelogram structure 32, which causes the pulley cage portion 34 to pivot outwardly from the wheel hub 9 to effectuate desired gear changes.

Referring now to FIG. 3, the derailleur 30 is shown in greater detail. Specifically, the upper deformable parallelogram 32 is comprised of a right side vertical leg 40 to which the lower pulley cage portion 34 is rigidly secured. In addition, the parallelogram 32 contains a left side vertical leg 42 that includes a detent bearing arm 50 as will be described herein. The parallelogram 32 also includes a top or upper horizontal leg 44 that contains a detent plate portion 54 containing a plurality of detents 56, each being positioned to represent a position of the parallelogram 32 that is associated with selection of one sprocket gear of the rear sprocket cassette 28. The leg 44 also contains an integral extension that receives the connection bolt 31 through an aperture therein not shown. Finally, the parallelogram 32 includes a lower or bottom horizontal leg 46; it will be appreciated that all of the respective legs are hinged together by means of connection grommets 48a, b, c, and d, as shown in FIG. 2.

As previously noted, the left side vertical leg 42 includes a detent bearing arm 50 that is hinged at a connection grommet 48a to the upper horizontal leg 44. It will be appreciated that the bottom of the left side vertical leg 42 overlies a pivot connection grommet 48d (hidden), by which the leg 42 is movably attached to the lower or bottom horizontal leg 46. Referring now also to FIG. 4A, a first described embodiment of the derailleur 30 incorporates a protuberance 52 that extends axially from the arm 50. The protuberance 52 is positioned and adapted to cooperate with detents 56 situated in the detent plate portion 54 of the top horizontal leg 44. In this embodiment, the detent bearing arm is formed of spring steel, and is adapted to have a threshold force that must be overcome via countering forces of a cable wire 68 to permit the protuberance 52 to become dislodged from, and to move from one detent 56 to a next adjacent detent 56. Movement of the cable wire 68 is effected via the lever 16, which as earlier noted is employed to effect gear shifts by a cycle operator. Even though this invention has been described with reference to cable actuation, the invention is broad enough to reach devices involving non-cable devices, such as those including hydraulic actuation or electric actuation, for example.

Referring now to FIG. 4B, an alternate embodiment of a detent mechanism is one of a spring-loaded ball 76 that is urged by a spring 74 into the plurality of selectable detents 56′, as will be appreciated by those skilled in the art.

Referring back to FIG. 3, a cable fastening boss 62 is formed integrally with the upper horizontal leg 44 of the deformable parallelogram 32. The boss 62 accommodates a cable fastening nut 64 to which an end of the cable wire 68 is secured. It will be appreciated that both the fastening boss and the cable fastening nut are situated mid-span of the horizontal leg 44. The cable wire 68 is contained within a cable housing 66 that is defined by a protective sheath adapted to permit sliding movement of the cable wire within the housing 66. A cable wire tension control 70 is threaded through an aperture 71 of a bulbous lower portion 72 of the left side vertical leg 42. The tension control 70 provides an adjustment mechanism for limiting and controlling movements of the derailleur 30 to thereby effectuate appropriate positioning of the derailleur guide pulley gear 38 relative to the selectable five sprocket gears of the rear sprocket cassette 28.

Thus, in accordance with one aspect of the present invention, a “detent” principle is employed to index the derailleur 30 to any one of the selectable sprocket gears of the rear sprocket cluster 28. The detents 56 are designed to be positively engaged by either a protuberance 52 or spring-loaded ball 76, such that a positive “digitally” changed gear position results. When the cable wire 68 is moved with sufficient force, the protuberance 52 or ball 76 will disengage from a particular detent 56 at a desired threshold force value, causing the protuberance or ball to ride on a surface of the detent plate portion 54 between detents until engagement of the next proximally positioned detent. The force limits for producing disengagement depend on the spring forces designed into the mechanism, as those skilled in the art will appreciate. Finally, the derailleur is adapted to move in either direction depending upon the direction of movement of the cable wire 68 for actuating the indexing mechanism.

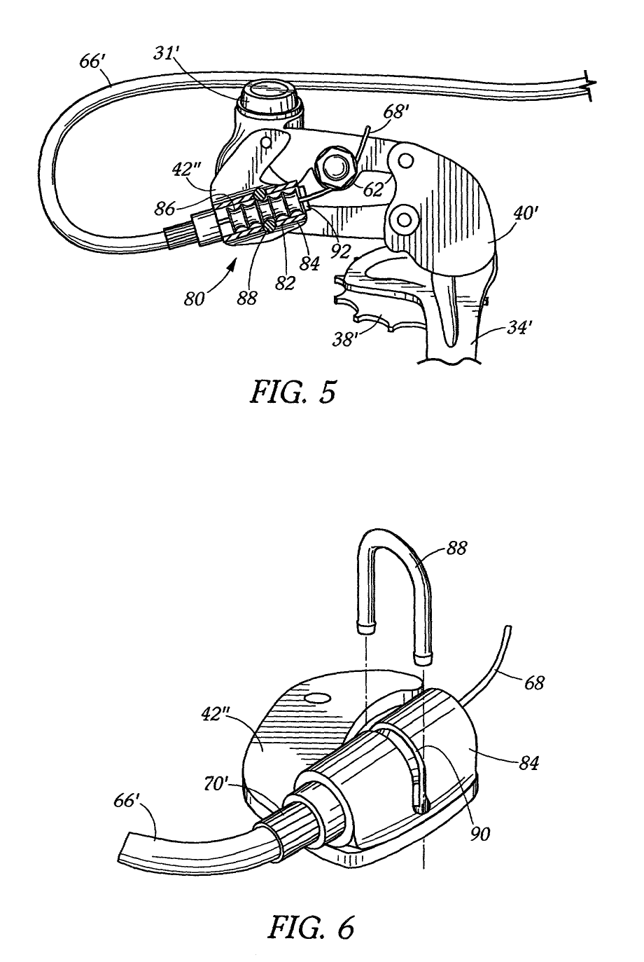

Another embodiment of the derailleur mechanism is displayed in FIGS. 5 and 6, wherein the bulbous portion 72 (FIG. 3) of the left side vertical leg 42 has been replaced by an arrangement 80 of a cooperating elongated piston sleeve 82 and cylinder 84. In FIG. 5, the top of the cylinder 84 has been cut away to reveal the piston sleeve 82. The sleeve 82 is adapted to move axially within and relative to the cylinder 84, and the surface of the piston sleeve 82 is scalloped in a manner to contain a series of adjoining ring grooves 86, wherein one groove position corresponds to one selectable sprocket gear of the rear cluster 28. The piston sleeve 82 is rigidly secured to the cable wire 68′ via a compression fitting 92, while the cylinder 84 is secured over the piston sleeve 82. The cylinder 84 is fixed directly to the left side vertical leg 42. Referring to FIG. 6, a U-shaped tension clip 88 (shown in an exploded view) is adapted to engage a slot 90 in the body of the cylinder 84, so as to fix the clip axially relative to any movement of the piston sleeve 82. The clip 88 thus interacts with the grooves 86 of the sleeve 82, wherein the described mechanism of FIGS. 5 and 6 provides another style of detent mechanism, as will be appreciated by those skilled in the art.

Indeed, as the cable wire 68′ is moved axially, operation of the lever 16 will be associated with a “feel” of the piston sleeve ring grooves overcoming a force threshold to slip past the tension clip 88 as necessary to shift from one gear to the next. Obviously, it will be appreciated that each of the ring grooves 86 is associated with a selectable sprocket gear of the rear sprocket cassette 28. Therefore, a distinct indexed sprocket gear selection may be achieved via manipulation of the cable wire 68′; such manipulation assures that a desired ring groove is selected that corresponds to desired gear ratio.

It is to be understood that the above description is intended to be illustrative and not limiting. Many embodiments will be apparent to those skilled in the art upon reading the above description. The scope of the invention should be determined, however, not with reference to the above description, but with reference to the appended claims with full scope of equivalents to which such claims are entitled.

What is claimed is:

1. A cycle gear shift mechanism adapted to change positions of a cycle drive gear chain from a first cycle sprocket gear to an adjacent second sprocket gear coaxially fixed with respect to said first cycle sprocket gear, said cycle gear shift mechanism comprising a derailleur and a shift indexer, wherein said shift indexer is an integral part of said derailleur.

2. The cycle gear shift mechanism of claim 1, wherein said indexer comprises a detent-style, spring-loaded protuberance.

3. The cycle gear shift mechanism of claim 1, wherein said indexer comprises a piston sleeve and cylinder arrangement, wherein said piston sleeve is adapted to move reciprocally within said cylinder.

4. The cycle gear shift mechanism of claim 3, wherein said cylinder comprises a slot transversely oriented with respect to said piston sleeve, said piston sleeve comprises a series of ring grooves, and each ring groove corresponds to one selectable sprocket gear position; a tension clip axially fixed in said slot, said clip oriented transversely with respect to each of said ring grooves, wherein said tension clip is displaced from one ring groove to an adjacent ring groove via a threshold force imposed on said piston sleeve.

5. The cycle gear shift mechanism of claim 3, further comprising a parallelogram defining a four-legged structure, wherein each of said four legs are serially hinged to two other of said legs via grommets, and wherein one of said legs comprises a boss to which is secured said sleeve and cylinder arrangement.

6. The cycle gear shift mechanism of claim 2, wherein said derailleur comprises an upper deformable parallelogram having a lower pulley cage portion secured to and supported by one leg of said parallelogram.

7. The cycle gear shift mechanism of claim 6, wherein said parallelogram comprises a four-legged structure, wherein said four legs are serially hinged together via grommets, and wherein one of said legs comprises a connection to one end of a gearshift control cable wire.

8. The cycle gear shift mechanism of claim 7, wherein a first of said legs comprises a detent plate portion containing a plurality of detents, wherein a second leg connected to said first leg comprises a detent bearing arm, and wherein said detent bearing arm comprises a protuberance positioned and adapted to cooperate with said plurality of detents in said detent plate portion of said first leg.

9. The cycle gear shift mechanism of claim 8, wherein said second leg comprising said detent bearing arm is hinged via a grommet to said leg that comprises a connection to said one end of a gearshift control cable wire, and wherein said connection comprises a boss.

10. The cycle gear shift mechanism of claim 9, wherein said first leg comprises said boss, and wherein said first leg also includes said detent plate portion.

11. The cycle gear shift mechanism of claim 7, wherein said detent bearing arm is formed of spring steel, and wherein said arm is adapted to be moved via a threshold force sufficient to overcome said threshold force via a force of said cable wire, wherein said force of said cable wire is adapted to dislodge said protuberance from one of said detents and to transfer said protuberance to another adjacent one of said detents.

12. The cycle gear shift mechanism of claim 7, wherein said protuberance comprises a spring-loaded ball.

13. The cycle gear shift mechanism of claim 8, wherein said boss is is situated mid-span of said first leg.

14. The cycle gear shift mechanism of claim 8, wherein said cable wire is contained within a cable housing that defines a protective sheath adapted to permit sliding movement of said cable wire within said housing.

15. The cycle gear shift mechanism of claim 3, wherein said pulley cage portion comprises a chain guide pulley gear adapted to reposition said cycle chain from one gear sprocket to another.

16. The cycle gear shift mechanism of claim 15, wherein said first and second cycle sprocket gears have different diameters.

17. The cycle gear shift mechanism of claim 8, wherein said indexer as well as said derailleur are both simultaneously activated via a gearshift control cable wire.

18. A cycle gear shift derailleur adapted to change positions of a cycle drive gear chain from a first cycle sprocket gear to an adjacent second sprocket gear that is coaxially fixed with respect to said first cycle sprocket gear, said derailleur comprising a shift indexer, wherein said shift indexer is integrally affixed to said derailleur, wherein said indexer comprises a physical part of said derailleur structure, and is activated by a gearshift control cable wire, said indexer comprising a detent-style, spring-loaded protuberance and said derailleur comprises an upper deformable parallelogram having a lower pulley cage portion secured to and supported by one leg of said parallelogram; said derailleur further comprising a first leg adapted to be fixed to a cycle frame, a second leg having a derailleur chain guide affixed thereto, said first and second legs adapted to move with respect to one another and comprising substantially parallel structures connected together via two links to define a deformable parallelogram-shaped four-bar linkage mechanism, wherein said shape of said parallelogram is controlled between two limits of movement via a shift derailleur cable wire extending through a sheath having a housing affixed to said first leg, and said cable having an end affixed to one of said links; said cable thereby adapted to control shifting of gear chain positions between said first and second cycle sprocket gears via follower movements of said chain guide through which the gear chain passes,
and wherein said gearshift derailleur shift indexer is directly affixed to said four-bar linkage mechanism, whereby said indexer accuracy is unaffected via control cable stretching.

19. A gear shifter system for a cycle comprising a gear cluster including at least two sprocket gears; said gears positioned coaxially in a side-by-side relationship, and adapted to receive a drive gear chain alternately passing over at least one of said gears of said gear cluster; a derailleur positioned proximally to each of said gears in said gear cluster, said derailleur having a chain guide for controlling passage therethrough of said drive gear chain; a shift indexer for positively positioning said chain on either one of said sprocket gears, and a pulley carriage gear attached to the chain guide; said system further comprising an actuator for transversely moving said derailleur to shift the chain from said one of the gears in said cluster to a next adjacent gear when said actuator is positively moved in one transverse direction, and to shift the chain from said next adjacent gear back to said one cluster gear when said actuator is moved in an opposite direction, wherein said actuator is a deformable parallelogram, and wherein a transverse movement of said indexer relative to said derailleur causes a corresponding movement of said pulley carriage gear attached to said chain guide, said pulley carniage gear having teeth adapted to engage said chain, and to thereby laterally displace said chain to effect a shifting of the chain from a first lateral position on said one gear to an adjacent lateral position on the next adjacent gear; said indexer being directly affixed to said derailleur.

20. The indexed cycle gear shifter system of claim 16, wherein said indexer comprises a spring-loaded detent mechanism.

21. The indexed cycle gear shifter system of claim 16, wherein said indexer comprises a ball and spring detent mechanism.

22. A cycle gear shift derailleur adapted to change positions of a cycle drive gear chain from a first selectable sprocket gear to an adjacent second sprocket gear that is coaxially fixed with respect to said first cycle sprocket gear; a shift indexer, wherein said shift indexer is integrally affixed to said derailleur, and wherein said indexer thereby comprises a physical part of said derailleur structure, and wherein said indexer activated by a gearshift control cable wire; said indexer further comprising a cooperating elongated piston sleeve and cylinder arrangement, wherein said sleeve is housed within, and adapted to move reciprocally within, said cylinder; said derailleur comprising an upper deformable parallelogram having a lower pulley cage portion secured to and supported by one leg of said parallelogram; said derailleur further comprising a first leg adapted to be fixed to a cycle frame, a second leg having a derailleur chain guide affixed thereto, said first and second legs adapted to move with respect to one another and comprising structures connected together via links to define a deformable parallelogram linkage mechanism, wherein said shape of said parallelogram is controlled between two limits of movement via a derailleur cable wire attached to said piston sleeve and cylinder arrangement; wherein the cylinder is affixed to said first leg;
said cylinder including a slot transversely oriented with respect to said piston sleeve, and said piston sleeve including a series of ring grooves, each ring groove corresponding to one selectable sprocket gear position;
a tension clip axially fixed in said slot transverse to each of said ring grooves of said piston sleeve within said cylinder, wherein said tension clip is displaced from one ring groove to an adjacent ring groove via a threshold force imposed on said piston sleeve via said cable, wherein said cable has an end affixed to one of said links; said cable being thereby adapted to control shifting of gear chain positions between said first and second cycle sprocket gears via follower movements of said chain guide through which the gear chain passes,
and wherein said shift indexer is directly affixed to said deformable parallelogram linkage of said derailleur, whereby said indexer accuracy with respect to gear sprocket selection is unaffected via stretching of said cable wire.

23. The cycle gearshift derailleur of claim 19, wherein said indexer and said derailleur are simultaneously activated via said derailleur cable wire.
